(19) United States
(12) Patent Application Publication
(10) Pub. No.: US 2015/0001165 A1
(43) Pub. Date: Jan. 1, 2015

(54) Filter Cleaning System and Method

(71) Applicant: Guillermo Duenas, Miami, FL (US)

(72) Inventor: Guillermo Duenas, Miami, FL (US)

(21) Appl. No.: 13/928,566

(22) Filed: Jun. 27, 2013

(51) Int. Cl. B01D 29/66

(52) U.S. Cl. CPC B01D 29/668
USPC 210/791; 210/409; 210/90

(57) ABSTRACT

A filter cleaning system and method utilizes stationary conduit frames to discharge a cleaning fluid onto a filter without requiring removal of the filter. An intake valve positions on a housing upper end for receiving the fluid from an external source. A primary conduit extends along a longitudinal axis of the housing to carry the fluid from the housing upper end to a housing lower end, and in proximity to the filter. A plurality of conduit frames join the primary conduit at predetermined intervals along the longitudinal axis of the housing. The fluid flows through the conduit frames. Each conduit frame includes a plurality of apertures oriented to face the filter and discharge fluid onto the filter. Throughout the process, the conduit frames remain stationary. Support rods provide longitudinal stability, while wedges provide lateral stability to the conduit frames. A release valve discharges fluid and debris after cleaning.

### BACKGROUND

The present invention is related to a filter cleaning system and method that cleans a filter with a stationary cleaning system, and allows the filter to remain within a filter tank during the cleaning process.

It is well known that swimming pool sanitation refers to methods for ensuring healthy conditions in swimming pools, hot tubs, plunge pools, and similar recreational water venues. Proper sanitation is needed to maintain the visual clarity of water and to prevent the transmission of infectious diseases.

A water filter removes impurities from water by means of a fine physical barrier, a chemical process, or a biological process. Filters cleanse water to different extents for purposes like irrigation, drinking water, aquariums, and swimming pools. Pleated paper type cartridge filters can be chained together to filter almost any size home pool. The cartridges are typically cleaned by removal from the filter housing and hosing-off down a sewer connection.

A sprayer is a device used to spray a liquid for cleaning. The sprayer can be used to remove debris, such as dirt, grime, carbon, oil, grease and corrosion from swimming pool cartridge filters. The sprayer often rotates or oscillates in proximity to the filter during cleaning to maximize contact with surface area.

Often, cleaning the filter requires multiple steps and a variety of tools. The steps must be performed chronologically to avoid mishaps and damage to the filter. An initial step for cleaning a swimming pool type filter requires releasing pressure from the housing, The housing upper end must then be removed. A next step includes removing the filter from the housing. This step may require tools to perform. The filter is then manually cleaned or replaced with a new filter. Finally, the housing upper end is reattached and a release valve is closed to increase water pressure for normal filtering operations. These steps can require much time and labor to perform.

Filter cleaning systems have been used in the swimming pool industry in the past, yet none with the present characteristics of the present invention. See U.S. Pat. Nos. 4,299,245; 3,650,283; and 5,300,065.

For the foregoing reasons, there is a need for a filter cleaning system and method that cleans the filter with a stationary sprayer without requiring the filter to be removed from the filter housing.

### SUMMARY

The present invention is directed to a filter cleaning system and method that utilizes stationary conduit frames to discharge a cleaning fluid onto a filter for cleaning. The filter cleaning system positions within housing, such ay a cylindrical swimming pool filter tank. The housing contains both the filter and the stationary conduit frames. An intake valve positions on a housing upper end for receiving the fluid from an external conduit, such as a high pressure hose. A primary conduit extends along a longitudinal axis of the housing to carry the fluid from the housing upper end to a housing lower end, and in proximity to the filter.

In one embodiment, a plurality of transversely spaced conduit frames join the primary conduit at predetermined intervals along the longitudinal axis of the housing. In this manner, each conduit frame receives and carries the same fluid, but at different positions along the filter. In one embodiment, the plurality of conduit frames may include annular pipes having a sufficient diameter to compass the filter, and sufficient area to carry the fluid for cleaning the filter. In one embodiment, each conduit frame is distinct and separate from the other, sharing only the fluid from the primary conduit. Further, each conduit frame includes a frame inner surface having a plurality of apertures oriented to face the filter. The fluid has sufficient pressure to discharge from the plurality of apertures, and onto the filter for removing debris. In some embodiments, the plurality of apertures may be shaped and dimensioned to discharge the fluid at a predetermined angle and velocity. For example, without limitation, an upper conduit frame comprises an aperture configured to discharge small droplets of the fluid at a high pressure; whereas a lower conduit frame comprises an aperture configured to discharge large fluid droplets at a low pressure. Those skilled in the art will recognize that the portion of the filter in the housing lower end receives fluid not only from an adjacent aperture, but also from apertures in the housing upper end, due to gravity and excess fluid flow cascading down the filter.

In one embodiment, the plurality of conduit frames includes a frame outer surface for at least partially engaging a housing inner surface. At least one wedge positions between the frame outer surface and the housing inner surface. The restriction applied by the wedge helps minimize movements, such as vibrations, on the plurality of conduit frames during both cleaning and normal filtering operation. The wedge may also help secure the plurality of conduit frames into a locked position. At least one support rod may provide additional support to lock the plurality of conduit frames into a predetermined position. The at least one support rod attaches to the housing lower end, extending upwardly to the housing upper end. The at least one support member is configured to attach to the frame inner surface or the frame outer surface for providing longitudinal structural support to the plurality of conduit frames.

In some embodiments, a release valve positions on the housing lower end for releasing excess fluid from the housing. The release valve may also be efficacious for discharging debris from dirty filters during cleaning. A pressure gauge positions on the housing upper end to display the pressure of the fluid inside the housing, both during normal filtering operations and during cleaning. Those skilled in the art will recognize that the filter cleaning operation is completed when a substantial amount of the fluid has been released from the housing, thereby resulting in a low pressure reading on the pressure gauge.

One novel filter cleaning system feature is a stationary conduit frame that discharges the fluid onto the filter axially, from different longitudinal positions along the housing. Since the conduit frame compasses the filter, the filter receives fluid from myriad directions, and also receives cascading fluid flow from upper sections of the filter. The plurality of apertures that discharge the fluid are also configured to provide various types of sprays at various types of pressures, depending on cleaning requirements, filter size, and type of fluid utilized.

Additional novelty is provided in that the at least one wedge and the at least one support rod provide sufficient rigidity to the plurality of conduit frames, such that high fluid pressure streams that discharge for cleaning remain steady and focused on a predetermined area of the filter. The at least one wedge inhibits vibrations and damage from physical contact with the housing inner surface, and provides latitudinal stability. The at least one wedge comprises a gap configured to receive the plurality of conduit frames. The at least one gap further comprises grippers to provide a grip against the housing inner surface. Likewise, the at least one support rod retains the plurality of conduit frames in an upright position, and provide longitudinal stability.

In one embodiment of the present invention, in operation, the filter cleaning method provides a novel process for cleaning the filter. The filter cleaning method may include an initial Step of removing pressure from the housing. The pressure may build up from normal filtering operations as the fluid substantially fills the housing. The step of removing the pressure requires opening the release valve until fluid and debris stops flowing out of the housing. The release valve may then be closed to commence the tittering process. The pressure gauge is monitored to help ascertain when the pressure has been released. The method may then proceed to a Step of coupling an external conduit to the intake valve o provide a source of fluid for the filter cleaning. The external conduit may include, without limitation, a garden hose from an external water spigot. The fluid may include, without limitation, water, bleach, salt water, peroxide, acid, slurry, gel, and gas.

In one embodiment, a Step includes discharging the fluid through the external conduit so that fluid flows through the filter cleaning system. The fluid may then pass through the intake valve, through the primary conduit, and finally discharge through the plurality of apertures from each individual conduit frame. The filter remains positioned inside the housing throughout the whole cleaning process. The pressure gauge is monitored to determine the amount of fluid buildup in the housing. Another Step includes engaging the filter with the fluid from the plurality of conduit frames. Each conduit frame is configured to encompass the filter at varying heights along the housing. The plurality of apertures orient to face the filter and provide a desired fluid velocity such that cleaning the filter is optimized during discharge of the fluid.

In one embodiment, a Step includes securing the plurality of conduit frames in a stationary position in the housing. The plurality of conduit frames does not have to pivot, slide, rotate, or oscillate to access the filter for cleaning. Those skilled in the art will recognize that since each conduit frame encompasses the filter, and the fluid produced from cleaning the filter in the housing upper end flows down onto tower sections of the filter, the filter receives sufficient fluid for cleaning. Further, the fluid buildup that occurs while the release valve is closed may submerge the filter in the fluid. A final Step comprises releasing the fluid buildup in the housing through the release valve. In this manner, the fluid and filter debris from the housing are removed, and the pressure decreases. These steps may be repeated with different fluids, For example, without limitation, an initial pass may utilize soapy water, and a second run may utilize a composition for revitalizing the filters. The filter cleaning system does not require tools to operate, other than a basic wrench to open and close the valves.

An objective of the present invention is to clean a filter without removing the filter from the housing. This serves to save time and minimize the amount of tools needed. Damage to the filter from removal and installation are also minimized.

In yet another objective, the conduit frame used to discharge the fluid onto the filter remains stationary. This helps reduce mechanical wear and tear on the filter cleaning system.

In yet another objective, the time and labor required to clean the filter are reduced since removal and cleaning of the filter are not manually done.

### DRAWINGS

These and other features, aspects, and advantages of the present invention will become better understood with regard to the following description, appended claims, and drawings where:

FIG. 1 is a sectioned view of the present invention showing an exemplary filter cleaning stem and a blowup view of an exemplary filter;

FIG. 2 is a sectioned view of the present invention showing an exemplary filter cleaning system with at least one wedge;

FIG. 3 is a blow up view of an exemplary wedge joined to a conduit frame;

FIG. 4is a close up view of an exemplary plurality of apertures discharging and exemplary fluid;

FIGS. 5A and 5B are close up views of an exemplary fluid engaging an exemplary filter to dislodge debris; and

FIG. 6 is a flowchart of the present invention showing an exemplary filter cleaning method.

### DESCRIPTION

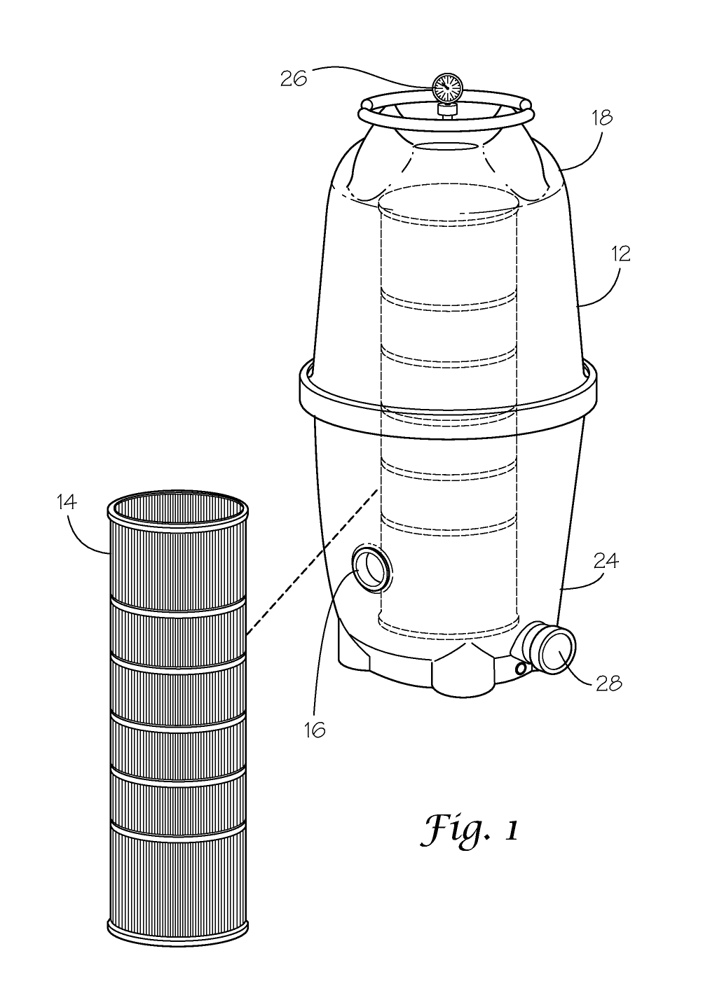

One embodiment of a filter cleaning system 10 is illustrated in FIGS. 1 through 5B. The filter cleaning system 10 comprises of the following: The filter cleaning system 10 positions within a housing 12. In some embodiments, the housing 12 may include a cylindrical swimming pool filter tank. However, the housing 12 may include various shapes, including, without limitation, a rectangle, a sphere, and a pyramid. The housing 12 contains a filter 14 and a stationary plurality of conduit frames 30 that discharge a fluid 44 onto the filter 14 for cleaning. An intake valve 116 positions on a housing upper end 18 for receiving the fluid 44 from an external conduit 20. The intake valve 16 may include a ball valve with a handle for regulating opening and closing. A primary conduit 22 extends along a longitudinal axis of the housing 12 to carry the fluid 44 from the housing upper end 18 to a housing lower end 24, and in proximity to the filter 14. The primary conduit 22 may include a polyvinyl chloride (PVC) pipe having sufficient diameter to feed the fluid 44 through the cleaning system 10.

In some embodiments, a pressure gauge 26 positions on the housing upper end 18. (FIG. 1.) The pressure gauge 26 is operable to display the pressure of the fluid 44 inside the housing, both during normal filtering operations and during cleaning. Those skilled in the art will recognize that the filter cleaning operation is completed when a substantial amount of the fluid 44 has been released from the housing 12, thereby resulting in a low pressure reading on the pressure gauge 26. The pressure gauge 26 helps ascertain when the filter cleaning process is complete, wherein a high pressure may indicate that the housing 12 is substantially full of the fluid 44. A release valve 28 located on the housing lower end 24 serves to discharge the fluid 44 and filter debris 64 from the housing 12. The release valve 28 may position on a curved surface on a housing floor so that the fluid 44 flows out of the housing 12 unrestricted.

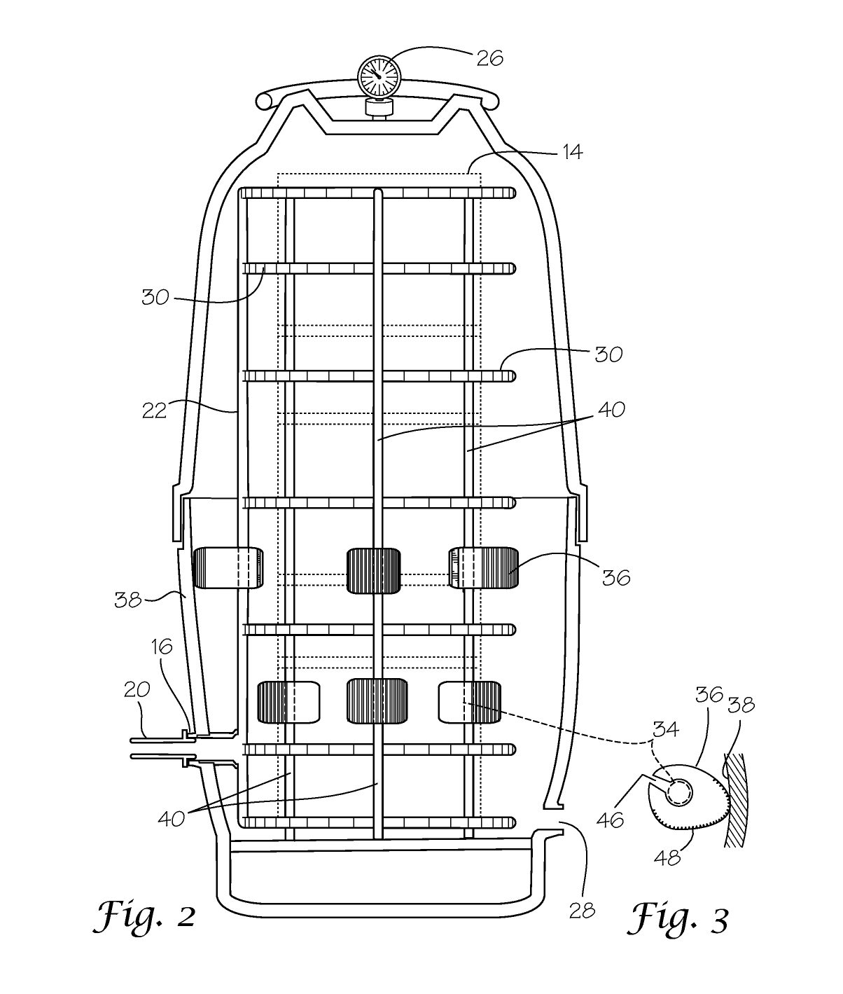

In one embodiment, a plurality of transversely spaced conduit frames 30 join the primary conduit 22 at predetermined intervals along the longitudinal axis of the housing, as referenced in FIG. 2. The connection between each conduit frame and the primary conduit may include, without limitation, a coupling, a weld, and a threaded end. In this manner, each conduit frame 30 receives and carries the same fluid 44, but at different positions along the filter 14. The plurality of conduit frames 30 may include annular tubes having a sufficient diameter to compass the filter 14, and sufficient area to carry the fluid 44 for cleaning the filter 14. In one embodiment, each conduit frame 30 is distinct and separate from the other, sharing only the fluid 44 from the primary conduit 22. However, in other embodiments, the plurality of conduit frames 30 join into a spiral tubing configuration, whereby the fluid 44 flows downwardly through an unbroken path in conformance with gravity. In yet another embodiment, the plurality of conduit frames 30 include various shapes, including, without limitation, an oval, a rhombus, a pyramid, and a cube. In any case, the plurality of conduit frames 30 compass the filter 14 and position at orientations efficacious for thorough cleaning of the filter 14.

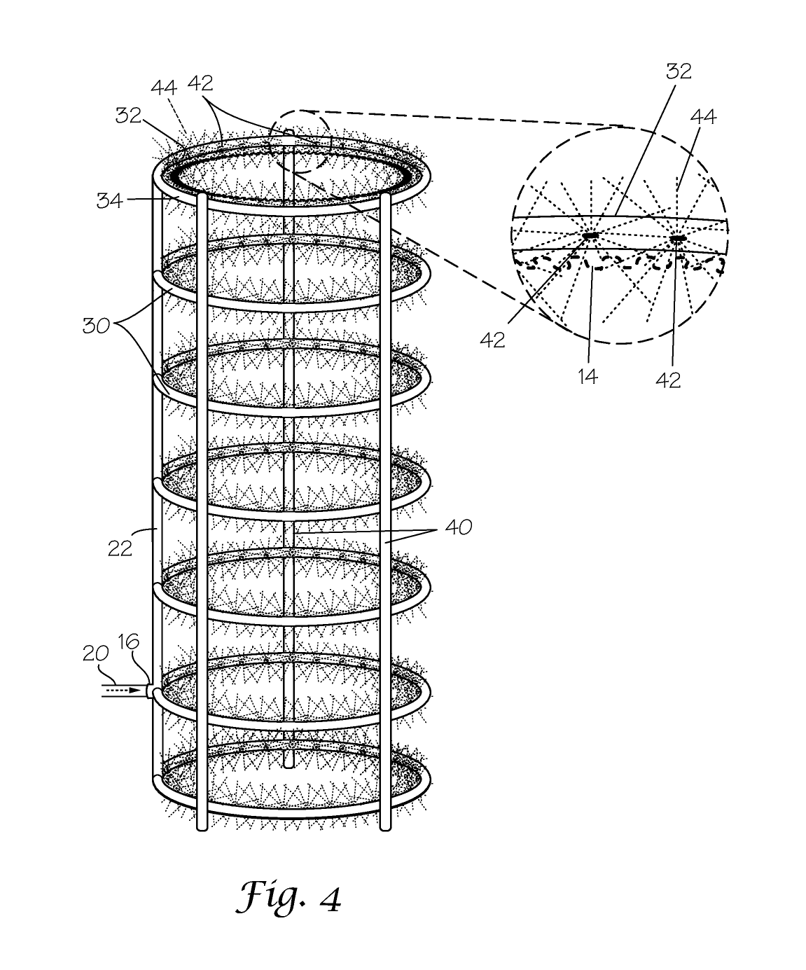

Further, each conduit frame 30 includes a frame inner surface 32 having a plurality of apertures 42 oriented to face the filter 14. The fluid 44 has sufficient pressure to discharge from the plurality of apertures 42, and onto the filter 14. The plurality of apertures 42 may include oval opening that serve as spray nozzles. In some embodiments, the plurality of apertures 42 may be shaped and dimensioned to discharge the fluid 44 at a predetermined angle and velocity. In yet another embodiment, the plurality of apertures 42 are sized and angle to provide optimal engagement with the filter 14. (FIG. 4) Each aperture 42 may include a flange for directional guidance. For example, without limitation, an upper conduit frame 30 comprises an aperture 42 configured to discharge small droplets of the fluid 44 at a high pressure; whereas a lower conduit frame 30 comprises an aperture 42 configured to discharge large droplets of the fluid 44 at a low pressure. Those skilled in the art will recognize that the portion of the filter 14 in the housing lower end 24 receives fluid 44 not only from an adjacent aperture 42, but also from apertures 42 in the housing upper end 18, due to gravity and excess fluid flow cascading down the filter 14. In one embodiment, each aperture 42 positions at least 2″ away from the other aperture 42.

In one embodiment, the plurality of conduit frames 30 includes a frame outer surface 34 for at least partially engaging a housing inner surface 38. At least one wedge 36 positions between the frame outer surface 34 and the housing inner surface 38. In some embodiments, the at least one wedge 36 utilizes an adhesive to secure against the housing inner surface 38 and the frame outer surface 34. The restriction applied by the at least one wedge 36 helps minimize movements, such as vibrations, on the plurality of conduit frames 30 during both cleaning and normal filtering operation. The wedge 36 may also help secure the plurality of conduit frames 30 into a locked position. Suitable materials for the at least one wedge 36 may include, without limitation, rubber, high density polymers, metal, alloys, and wood.

In one embodiment of the present invention, at least one support rod 40 provides additional support to lock the plurality of conduit frames 30 into a predetermined position. The at least one support rod 40 attaches to the housing lower end 24, extending upwardly to the housing upper end 18. The at least one support rod 40 is configured to attach to the frame inner surface 32 or the frame outer surface 34 for providing longitudinal structural support to the plurality of conduit frames 30. In one embodiment, three support rods 40 attach to the frame outer surface 34 at equidistant points.

In one embodiment, the release valve 28 positions on the housing lower end 24 for releasing excess fluid 44 from the housing 12. The release valve 28 may also be efficacious for discharging debris 64 from dirty filter 14s during cleaning. Opening the release valve 28 serves to remove the debris 64 from the filter, and also to reduce the pressure in the housing 12. This is an indication that the filter 14 is clean.

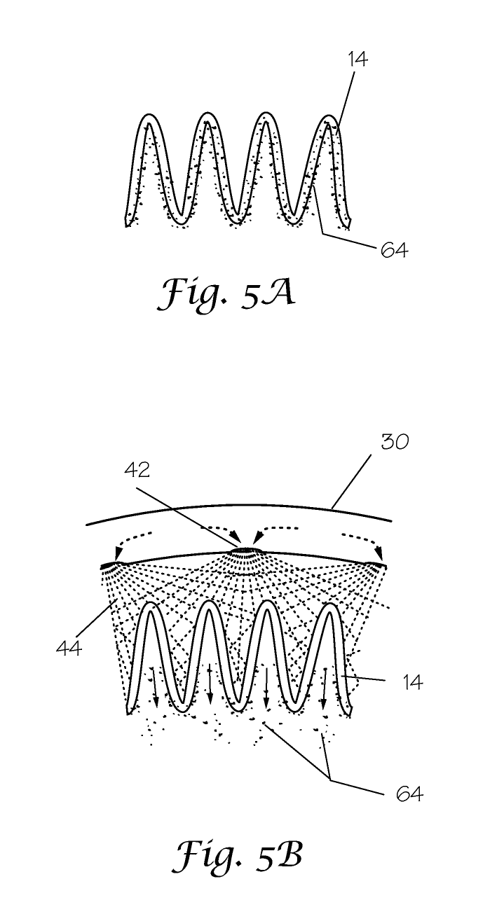

One novel filter cleaning system 10 feature is a stationary conduit frame 30 that discharges the fluid 44 onto the filter 14 axially, from different longitudinal positions along the housing 12. Since the plurality of conduit frames 30 compasses the filter 14, the filter 14 receives fluid 44 from various directions and fluid velocities. The filter 14 also receives cascading fluid flow from upper sections of the filter 14. The plurality of apertures 42 that discharge the fluid 44 are also configured to provide various types of spray at various types of pressures, depending on cleaning requirements, filter size, and type of fluid 44 utilized (FIGS. 5A and 5B).

Additional novelty is provided in that the at least one wedge 36 and the at least one support rod 40 provide sufficient rigidity to the plurality of conduit frames 30, such that high pressure fluid 44 streams that discharge for cleaning remain steady and focused on a predetermined area of the filter 14. The at least one wedge 36 inhibits vibrations and damage from physical contact with the housing inner surface 38, and provides latitudinal stability. Likewise, the at least one support rod 40 retains the plurality of conduit frames 30 in an upright position, and provide longitudinal stability. The at least one wedge 36 comprises a gap 46 configured to receive the plurality of conduit frames 30. The at least one wedge 36 further comprises grippers 48 to provide a grip against the housing inner surface 38 (FIG. 3).

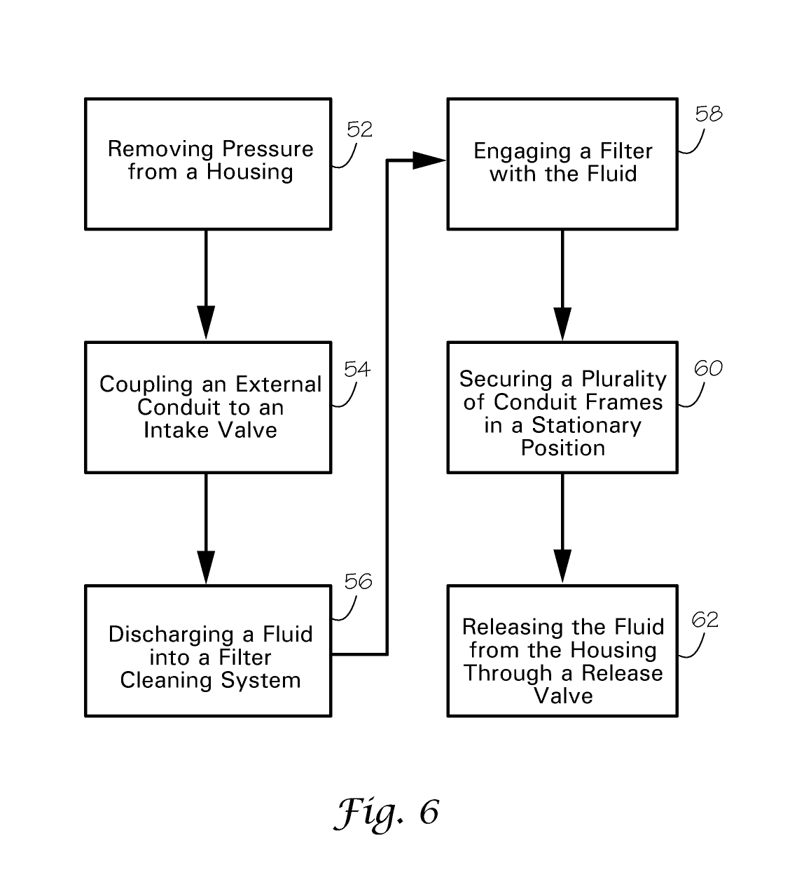

In one embodiment of the present invention, in operation, a filter cleaning method 50 provides a novel process for cleaning the filter 14, as referenced in FIG. 6. The filter cleaning method 50 may include an initial Step 52 of removing pressure from the housing 12. The pressure may build up from normal filtering operations as the fluid 44 substantially fills the housing 12. The step of removing the pressure requires opening the release valve 28 until fluid 44 and debris 64 stops flowing out of the housing 12. The release valve 28 may then be closed to commence the filtering process. The pressure gauge 26 may be monitored to help ascertain when the pressure has been released from the housing 12, and thereby when the filter 14 is clean. The method 50 may then proceed to a Step 54 of coupling an external conduit 20 to the intake valve 16 to provide a source of fluid 44 for cleaning the filter 14. The external conduit 20 may include, without limitation, a garden hose from an external water spigot. The fluid 44 may include, without limitation, water, bleach, salt water, peroxide, acid, slurry, gel, and gas.

In one embodiment, a Step 56 includes discharging the fluid 44 through the external conduit 20 so that fluid 44 flows through the filter cleaning system 10. The fluid 44 may then pass through the intake valve 16, through the primary conduit 22, and finally discharge through the plurality of apertures 42 from each individual conduit frame 30. The filter 14 remains positioned inside the housing 12 throughout the whole cleaning process. The pressure gauge 26 is monitored to determine the amount of fluid 44 buildups in the housing 12. Another Step 58 includes engaging the filter 14 with the fluid 44 from the plurality of conduit frames 30. Each conduit frame 30 is configured to encompass the filter 14 at varying heights along the housing 12. The plurality of apertures 42 orient to face the filter 14 and provide a desired fluid velocity such that cleaning the filter 14 is optimized during discharge of the fluid 44.

In one embodiment, a Step 60 includes securing the plurality of conduit frames 30 in a stationary position in the housing 12. The plurality of conduit frames 30 does not have to pivot, slide, rotate, or oscillate to access the filter 14 for cleaning. Those skilled in the art will recognize that since each conduit frame encompasses the filter 14, and the fluid 44 produced from cleaning the filter 14 in the housing upper end 18 flows down onto lower sections of the filter 14, the filter 14 receives sufficient fluid 44 for cleaning. Further, the fluid 44 buildup that occurs while the release valve 28 is closed may submerge the filter 14 in the fluid 44. A final Step 62 comprises releasing the fluid 44 buildup in the housing 12 through the release valve 28. In this manner, the fluid 44 and filter debris 64 from the housing 12 are removed, and the pressure decreases. These steps may be repeated with different fluid 44. For example, without limitation, an initial pass may utilize soapy water, and a second run may utilize a composition for revitalizing the filter 14. The filter cleaning system 10 does not require tools to operate, other than a basic wrench to open and close the intake valve 16 and the release valve 28.

Thus the reader will see that the filter cleaning system 10 and method 50 provides an efficient process for cleaning the filter 14, and efficacious for eliminating the need to remove the filter 14 from the housing 12 during the cleaning of the filter 14.

While the inventor's above description contains many specificities, these should not be construed as limitations on the scope, but rather as an exemplification of several preferred embodiments thereof. Many other variations are possible. For example, the filter cleaning system 10 could be utilized for cleaning large filters 14 in factories. Accordingly, the scope should be determined not by the embodiments illustrated, but by the appended claims and their legal equivalents.

What is claimed is:

1. A cleaning system for cleaning a filter, the cleaning system comprising:
a housing, the housing being configured to contain the cleaning system, the housing comprising a housing upper end and a housing lower end, the housing upper end comprising an intake valve, the intake valve being configured to receive a fluid from an external conduit, the housing lower end comprising a release valve, the release valve being configured to discharge the fluid from the housing after cleaning;
a primary conduit, the primary conduit being disposed to join with the intake valve, the primary conduit being configured to carry the fluid along a. longitudinal axis of the housing;
a plurality of conduit frames, each conduit frame being disposed to couple with the primary conduit, each conduit frame further being disposed to position in proximity to the filter, each conduit frame comprising a frame inner surface and a frame outer surface, the frame inner surface comprising a plurality of apertures for discharging the fluid onto the filter; and
at least one support rod, the at least one support rod being disposed to extend from the housing lower end to the housing upper end, the at least one support rod being configured to secure the plurality of conduit frames in a stationary position,
wherein the plurality of conduit frames discharge the fluid on the filter for cleaning while in the stationary position.

2. The cleaning system of claim 1, wherein the housing comprises a substantially cylindrical shape.

3. The cleaning system of claim 1, wherein the housing comprises a pressure gauge for ascertaining the amount of fluid in the housing during filtering operations and filter cleaning.

4. The cleaning system of claim 1, wherein the plurality of conduit frames comprises annular pipes that encompass the filter.

5. The cleaning system of claim 1, wherein the plurality of apertures are oriented to face towards the filter.

6. The cleaning system of claim 1, wherein the plurality of apertures are shaped and dimensioned to discharge the fluid at a predetermined angle and velocity.

7. The cleaning system of claim 1, wherein an upper conduit frame comprises an aperture configured to discharge small droplets of the fluid at a high pressure.

8. The cleaning system of claim 1, wherein a lower conduit frame comprises an aperture configured to discharge large fluid droplets at a low pressure.

9. The cleaning system of claim 1, wherein the frame outer surface at least partially engages a housing inner surface.

10. The cleaning system of claim 1, herein at least one wedge positions between the frame outer surface and the housing inner surface for suppressing vibrations.

11. The cleaning system of claim 10, wherein the at least one wedge comprises a gap, the gap being configured at least partially receive the plurality of conduit frames for providing a secure attachment.

12. The cleaning system of claim 11, wherein the at least one wedge comprises grippers for providing a grip against the housing inner surface.

13. The cleaning system of claim 1, wherein the at least one support rod comprises three support rods attached to the lower housing end and the plurality of conduit frames.

14. The cleaning system of claim 13, wherein the three support rods attach at equidistant points along the frame outer surface.

15. A cleaning method for cleaning filters, the cleaning method comprising:
removing pressure from a housing;
coupling an external conduit to an intake valve;
discharging a fluid through a filter cleaning system;
engaging a filter with the fluid from a plurality of conduit frames;
securing the plurality of conduit frames in a stationary position; and
releasing the fluid from the housing.

16. A cleaning system for cleaning a filter, the cleaning system consisting of:
a housing, the housing being configured to contain the cleaning system, the housing comprising a cylindrical shape, the housing comprising a housing upper end and a housing lower end, the housing upper end comprising an intake valve, the intake valve being disposed to join with an external conduit, the intake valve being configured to receive a fluid from an external conduit, the fluid comprising water, the housing lower end comprising a release valve, the release valve being configured to discharge the fluid from the housing after cleaning, the housing further comprising a pressure gauge to ascertain a quantity of the fluid in the housing;
a primary conduit, the primary conduit comprising a pipe, the primary conduit being disposed to join with the intake valve, the primary conduit being configured to carry the fluid along a longitudinal axis of the housing;
a plurality of conduit frames, each conduit frame being disposed to couple with the primary conduit, each conduit frame further being disposed to position in proximity to the filter, each conduit frame comprising an annular pipe, each conduit frame comprising a frame inner surface and a frame outer surface, the frame inner surface comprising a plurality of apertures for discharging the fluid onto the filter, the plurality of apertures being oriented to face the filter;
at least one wedge, the at least one wedge being disposed to position between the frame outer surface and a housing inner surface for restricting vibrations; and
three support rods, the three support rods being disposed to extend from the housing lower end to the housing upper end, the three support rods being configured to secure the plurality of conduit frames in a stationary position,
wherein the plurality of conduit frames discharge the fluid on the filter for cleaning while in the stationary position.
